(19) United States
(12) Patent Application Publication
(10) Pub. No.: US 2014/0090282 A1
(43) Pub. Date: Apr. 3, 2014

(54) SPOKE FLAG

(71) Applicant: RODERICK SEDLIACIK, Pasadena, CA (US)

(72) Inventor: RODERICK SEDLIACIK, Pasadena, CA (US)

(21) Appl. No.: 13/644,237

(22) Filed: Oct. 3, 2012

(51) Int. Cl. G09F 17/00

(52) U.S. Cl. CPC G09F 17/00
USPC 40/666; 116/173; 40/299.01

(57) ABSTRACT

A spoke flag made of weather-resistant and tear-resistant material may be wrapped around a single spoke such as a bicycle spoke. The spoke flag may wrap around the spoke on one end of the spoke flag and may be secured thereto by means of a single strip of double-sided tape which sticks to both the spoke and spoke flag, or by a clip or clamps. The length of the flag may be sufficient to flutter when in motion. The spoke flag may include various artistic designs and may include advertising.

### CROSS REFERENCE TO RELATED APPLICATIONS

This application claims the priority benefit of provisional application No. 61/544,893, filed Oct. 7, 2011.

### BACKGROUND OF THE INVENTION

The present invention relates to flags and, more particularly, to flags attachable to spokes.

Conventional material attachable to spokes may be rigid material attached to multiple spokes. Such material may not flutter during movement of the spoke.

As can be seen, there is a need for a fluttering spoke flag.

### SUMMARY OF THE INVENTION

In one aspect of the present invention, a spoke flag may comprise a body made of a flexible, weather-resistant and tear-resistant uncoated or coated paper, wherein the body has a first face and a second face, wherein the first face of the body includes one end with a single strip of double-stick tape, wherein the end of the first face with the one strip of double-stick tape is adapted to be wrapped around a single spoke, and wherein the single strip of double-stick tape when wrapped around the spoke adheres to both the spoke and a surface of the first face of the body.

In another aspect of the present invention, a spoke flag may include a body made of a flexible material, wherein the body has a first face and a second face, and a clip or clamps which secure the body to the spoke.

These and other features, aspects and advantages of the present invention will become better understood with reference to the following drawings, description and claims.

### BRIEF DESCRIPTION OF THE DRAWINGS

FIG. 1 illustrates a front view of a spoke flag according to an exemplary embodiment of the present invention showing a first side of the flag;

FIG. 2 illustrates a front view of the spoke flag of FIG. 1 showing a second shape for the spoke flag;

FIG. 3 illustrates a front view of the spoke flag of FIG. 1 showing a third shape for the spoke flag;

FIG. 4 illustrates a front view of the spoke flag of FIG. 1 showing a second side of the spoke flag;

FIG. 5 illustrates a front view of the spoke flag of FIG. 2 showing a second side of the spoke flag;

FIG. 6 illustrates a front view of the spoke flag of FIG. 3 showing a second side of the spoke flag;

FIG. 7 illustrates a front view of the spoke flag of FIG. 1 showing the spoke flag mounted on a spoke;

FIG. 8 illustrates a front view of the spoke flag of FIG. 2 showing the spoke flag mounted on a spoke;

FIG. 9 illustrates a front view of the spoke flag of FIG. 3 showing the spoke flag mounted on a spoke; and

FIG. 10 illustrates a perspective front view of the spoke flag of FIG. 1 showing the spoke flag in working position.

FIG. 11 illustrates a perspective front view of the spoke flag of FIG. 1 showing a clip.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a flag designed to be secured onto a spoke of, for example, a bicycle.

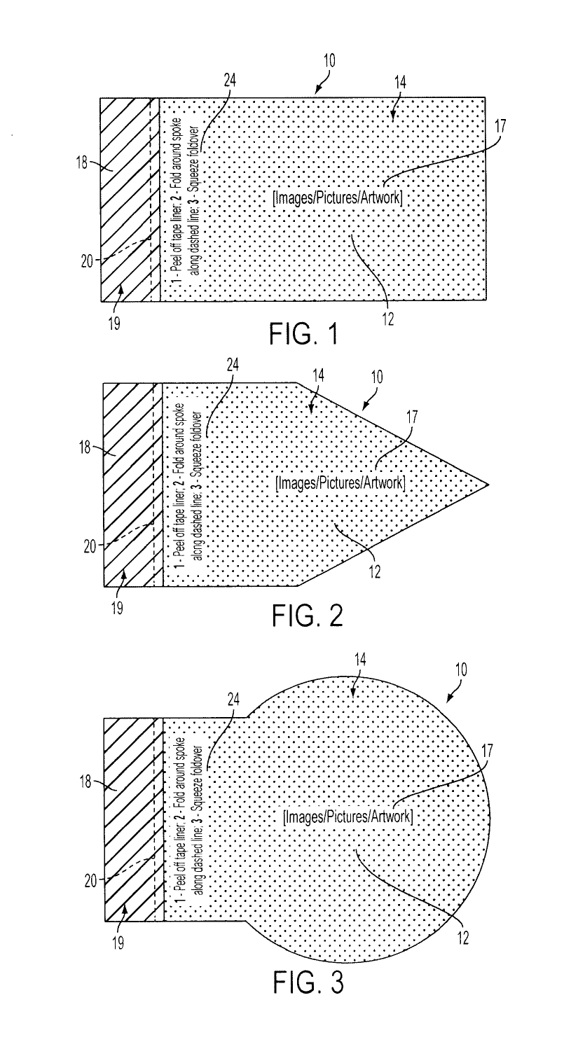

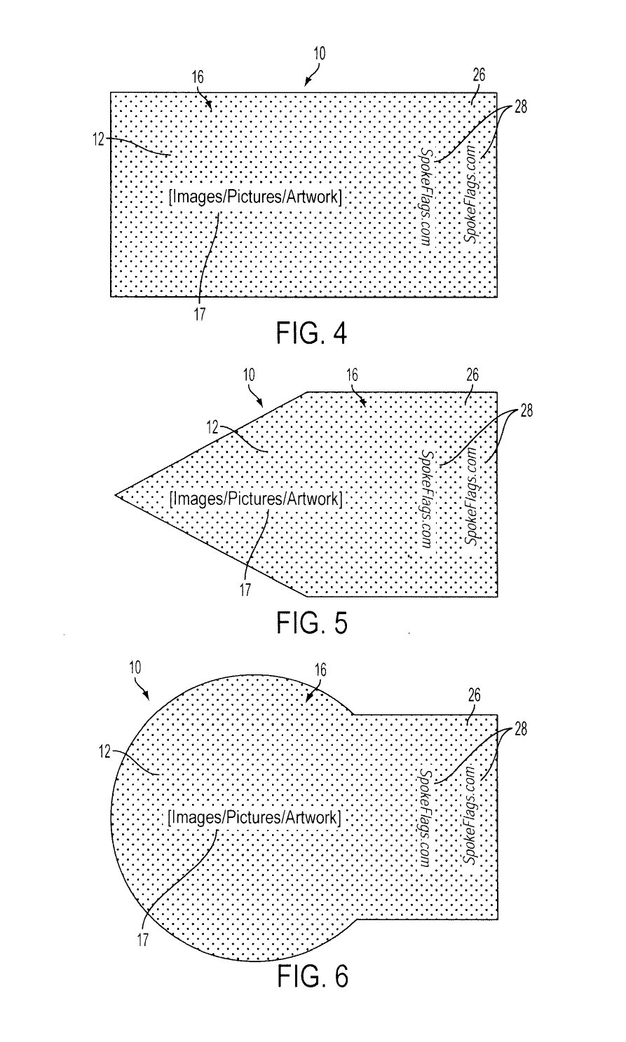

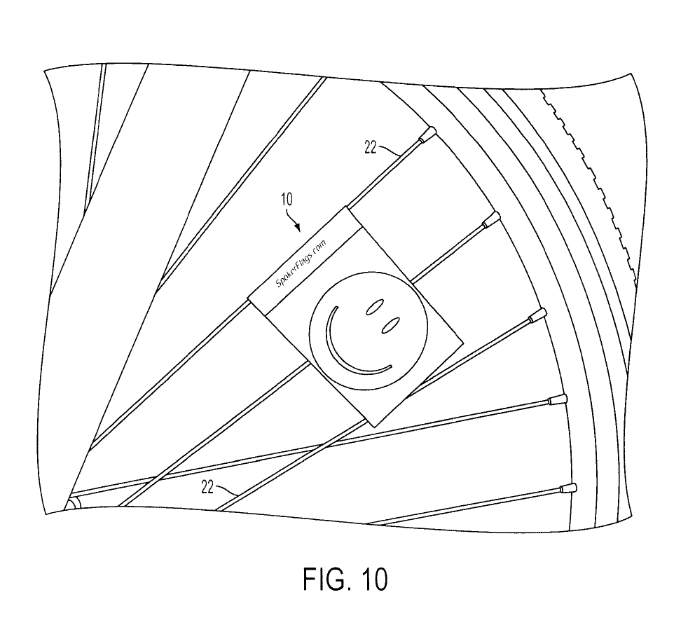

FIGS. 1-10 show a spoke flag 10 according to an exemplary embodiment of the present invention. The spoke flag 10 may include a body 12 having a first face 14 and a second face 16. The body 12 may be made of a flexible, weather-resistant and tear-resistant uncoated or coated material such as, for example, synthetic paper. In some embodiments, the body 12 may be made of, for example, PaperTyge® manufactured by Chase Corporation. PaperTyger® may provide the spoke flag 10 with the weather and tear resistant properties of synthetic paper with the benefit of an uncoated paper printing surface. PaperTyge® may allow the user to print on the spoke flag 10. PaperTyge® may provide the spoke flag 10 with fold endurance.

The shape and size of the body 12 may be, for example, a customizable shape. The shape of the spoke flag 10 may be, for example, rectangles, triangles, circles, squares, ovals, stars, hearts, flowers, foods, holiday motifs, animals, butterflies, fishes, or birds. The body 12 may have, for example, a height 42 of between approximately 1 and 4 inches and a length 44 of between approximately 2 and 6 inches. The size of the body 12 may not interfere with the safe and normal operation of the bicycle. The length 44 of the body may be sufficient to flutter when the bicycle is in motion. The length 44 of the body may be sufficient to span a plurality of gaps between spokes 22 of a bicycle wheel. The height 42 may be sufficient to provide space for the printed matter (images/pictures/artwork/advertisement/decoration) on the body 12.

Advertising information, artwork, or decorations 17 may be printed on the first face 14 and the second face 16 of the body 12.

The first face 14 of the body 12 may include an end with a single strip of double-stick tape 18 which may span the height of that end and may have, for example, a width of between approximately half an inch and one inch. The single strip of double-stick tape 18 when wrapped around the spoke 22 may adhere to both the spoke 22 and a surface of the first face 14 of the body 12. Alternatively, the single strip of double-stick tape 18 when wrapped around the spoke 22 may adhere to both the spoke 22 and to itself. Folding guidelines 20 may be included on the same end with the double-stick tape 18. The folding lines 20 may serve as a guide for placing the spoke flag 10 onto a spoke 22.

A liner 19 may be placed over the double-stick tape 18 for protection until it is time for its use.

Instructions 24 on how to fold the end with the single strip of double-stick tape 18 around the spoke 22 may be included next to the double-stick tape 18, or under the see-through double-stick tape 18 which is revealed when the tape liner is removed to expose the adhesive or on the liner 19, the first face 14, or on another part of the spoke flag 10. When in use, the double-stick tape 18 may be attached to both the spoke 22 and the first face 14 in the general area of the instructions 24, as it may grip and hold if stuck onto the spoke and the first face. The end 26 of the second face 16 of the body 12 may include advertising material 28.

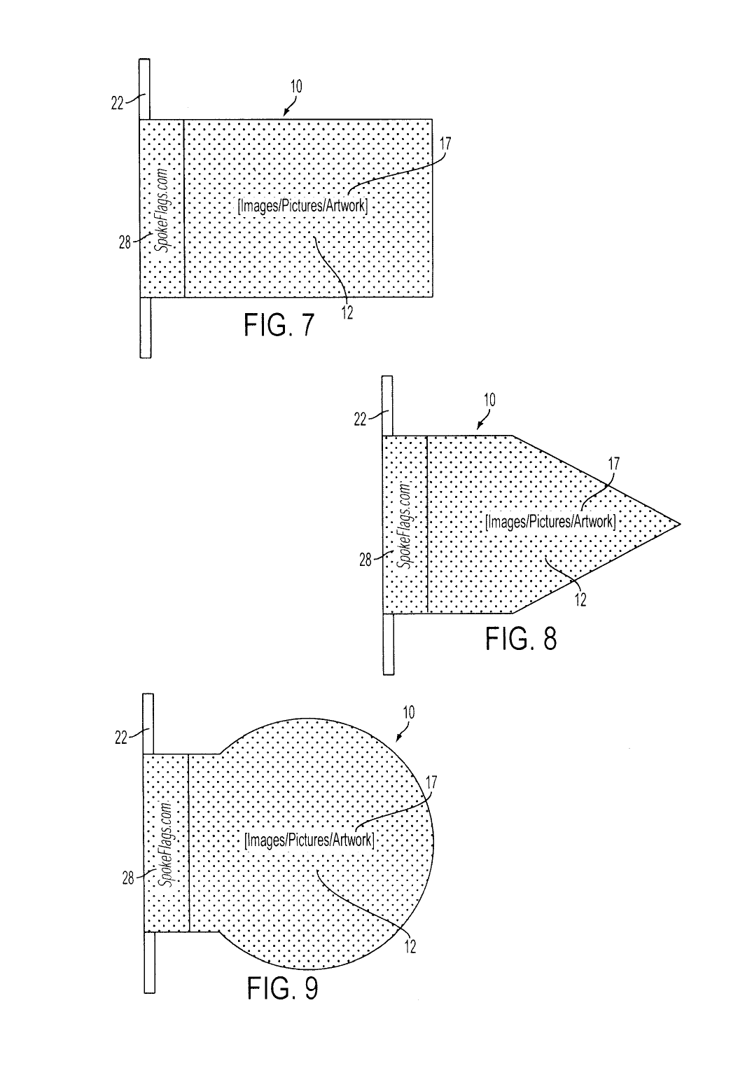

FIGS. 7-9 show that the spoke flag 10 may be mounted directly onto one spoke 22 of, for example, the bicycle.

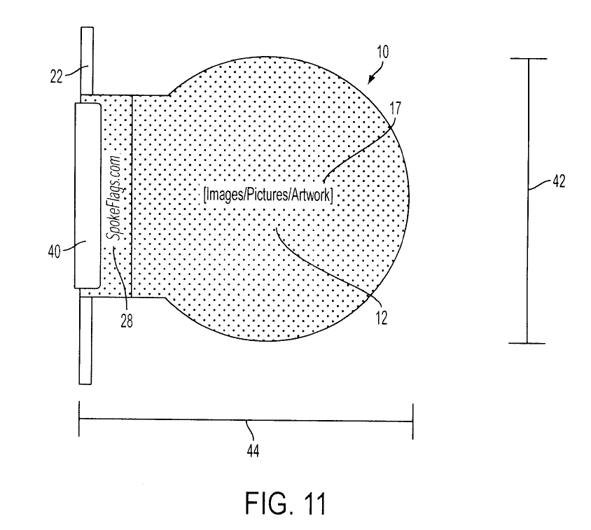

Referring to FIG. 11, a clip or clamps 40 may be used to secure the spoke flag 10 to the spoke 22.

The user (not shown) may peel off the liner 19 from the single strip of double-stick tape 18. Then, the user may place the spoke 22 on the end near the location of the folding line 20. The user may then fold the end with the tape 18 around the folding line 20 wrapping it around the spoke 22.

It should be understood, of course, that the foregoing relates to exemplary embodiments of the invention and that modifications may be made without departing from the spirit and scope of the invention as set forth in the following claims.

1. A bicycle spoke flag comprising:
a body made of a flexible, weather-resistant and tear-resistant uncoated or coated paper,
wherein the body has a first face and a second face, wherein the first face of the body includes one end with a single strip of double-stick tape,
wherein the end of the first face with the one strip of double-stick tape is adapted to be wrapped around no more than a single spoke of the bicycle, and
wherein the single strip of double-stick tape when wrapped around the spoke of the bicycle, adheres to both the spoke of the bicycle and a surface of the first face of the body, and
wherein the strip of double-stick tape includes folding guidelines configured to serve as a guide for placing the bicycle spoke flag onto the spoke of the bicycle.

2. The bicycle spoke flag of claim 1, wherein the bicycle spoke flag has a shape selected from the group consisting of: rectangle, triangle, circle, oval, star, heart, flower, food, holiday motif, or animal.

3. The bicycle spoke flag of claim 1, wherein the bicycle spoke flag has a height of between 1 and 4 inches and a length of between 2 and 6 inches.

4. The bicycle spoke flag of claim 1, wherein the single strip of double-stick tape has a width of between one half inch and one inch.

5. (canceled)

6. The bicycle spoke flag of claim 1, wherein instructions on how to fold an end of the bicycle spoke flag around the bicycle spoke are attached to the bicycle spoke flag adjacent to or under the single strip of see-through double-stick tape with liner.

7. The bicycle spoke flag of claim 1, wherein advertising material is affixed onto the body;

8. The bicycle spoke flag of claim 1, wherein artwork is affixed onto the body.

9. A bicycle spoke flag including:
a body made of a flexible weather-resistant and tear resistant material,
wherein the body has a first face and a second face,
a clip which is configured to secure the body to no more than a single bicycle spoke,
wherein advertising material is affixed onto the body in duplicate versions wherein a first one of the duplicate versions of the advertising material is displayed in an opposite direction to a second one of the duplicate versions.

10. (canceled)

11. The bicycle spoke flag of claim 9, wherein artwork is affixed onto the body.

12. The bicycle spoke flag of claim 9, including a plurality of clamps which secure the bicycle spoke flag to the bicycle spoke.
